(19) United States
(12) Patent Application Publication
(10) Pub. No.: US 2024/0402305 A1
(43) Pub. Date: Dec. 5, 2024

(54) Compact LiDAR Sensor

(71) Applicant: HUAWEI TECHNOLOGIES CO., LTD., Shenzhen (CN)

(72) Inventors: Daniel Manssen, Munich (DE); Sebastian Schweyer, Munich (DE); Uensal Kabuk, Munich (DE)

(21) Appl. No.: 18/680,905

(22) Filed: May 31, 2024

Related U.S. Application Data
(63) Continuation of application No. PCT/EP2021/083727, filed on Dec. 1, 2021.

(51) Int. Cl. G01S 7/481; G01S 17/931

(52) U.S. Cl. CPC G01S 7/4817; G01S 7/4814; G01S 7/4816; G01S 17/931

(57) ABSTRACT

A Light Detection and Ranging (LiDAR) sensor for sensing one or more objects including a transmitter configured to emit laser radiation along an axis of the LiDAR sensor and a scanner comprising a first lens array and a second lens array. The first and the second lens array are configured to emit the laser radiation received from the transmitter and to receive reflected laser radiation from the one or more objects at a steering angle relative to the axis of the LiDAR sensor. The LiDAR sensor further includes a receiver including an imager and a detector, wherein the imager is configured to direct the reflected laser radiation received from the scanner onto the detector. The scanner configured to adjust a relative position between the first and second lens array for adjusting the steering angle.

### CROSS-REFERENCE TO RELATED APPLICATIONS

This application is a continuation of International Application No. PCT/EP2021/083727, filed on Dec. 1, 2021, the disclosure of which is hereby incorporated by reference in its entirety.

### FIELD

The present disclosure relates to three-dimensional (3D) sensing apparatuses and describes a Light Detection and Ranging (LiDAR) sensor and a method of operating the LiDAR sensor for sensing one or more objects.

### BACKGROUND

LiDAR sensors are used for a variety of applications like autonomous driving and 3D depth sensing by smartphones. Modulated or pulsed laser radiation, which is send out by a transmitter unit, will be reflected or scattered by one or more target objects. The returning laser radiation will be collected by a receiver unit and converted into an electrical signal by the optoelectronic detector for further signal processing. Based on the runtime of the laser radiation the distance of the one or more target objects can be determined. This principle is also called time of flight (TOF). Alternatively, the distance can be determined by frequency or amplitude modulated continuous waves (FMCW or AMCW). A certain field of view (FOV) of the LiDAR system can be achieved by steering at least one laser beam, which is emitted by the transmitter unit, across the scene using a scanner unit. The same scanner unit or other scanner units can be used by the receiver unit to collect the returning, i.e. reflected laser radiation and image it onto the detector.

There are four major beam steering or scanning concepts currently used for LiDAR sensors.

For mechanical beam steering using macroscopic mirrors or prisms the laser beam is scanned along the scene by one or more rotating mirrors or prisms. Alternatively the entire LiDAR sensor is rotated. Such systems have a poor reliability and lifetime, are bulky, have high costs and typically provide only low resolution.

For mechanical beam steering using micro-electromechanical system (MEMS) mirrors the laser beam is scanned along the scene by one or more MEMS mirrors. Such systems have only moderate detection ranges due to small MEMS aperture, a poor reliability, and high costs due to complex MEMS architecture. Furthermore, they provide only low steering angles.

In solid state LiDAR systems the scanning of the scene is realized by an array of laser emitters which are alternately switched on. The different emitter positions are mapped into different angular directions using an imaging lens. The back reflected laser radiation is imaged onto a 2D detector array using an imaging lens. If high sensor resolution are needed, these systems require large laser and detector arrays which lead to high costs, as well as a poor manufacturing yield.

In LiDAR systems based on optical phased arrays the scanning of the laser beam is realized by an array of optical antennas. Each antenna is configured to introduce a certain phase delay with respect to the adjacent antenna. This relatively young technology still suffers from small steering angles, poor reliability, high costs, manufacturing yield issues, and a high power consumption.

### SUMMARY

The present disclosure provides solutions to the problems described above and provides an improved LiDAR sensor.

According to a first aspect, a LiDAR sensor for sensing one or more objects is provided. The LiDAR sensor comprises: a transmitter unit configured to emit laser radiation along an axis of the LiDAR sensor: a scanner unit comprising a first lens array and a second lens array, wherein the first and the second lens array are configured to emit the laser radiation received from the transmitter unit and to receive reflected laser radiation from the one or more objects at a steering angle relative to the axis of the LiDAR sensor; and a receiver unit comprising an imaging unit and a detector, wherein the imaging unit is configured to direct the reflected laser radiation received from the scanner unit onto the detector; wherein the scanner unit is configured to adjust a relative position between the first and second lens array for adjusting the steering angle.

The axis may be a longitudinal axis of the LiDAR sensor and/or may substantially correspond to the optical axis of the LiDAR sensor. The laser radiation may comprise one or more laser beams.

The LiDAR sensor further comprises a scanner unit comprising a first lens array and a second lens array. The first lens array and the second lens array may be arranged substantially perpendicular to the axis of the LiDAR sensor. The first and the second lens array are configured to emit the laser radiation received from the transmitter unit and to receive reflected laser radiation from the one or more objects at a steering angle relative to the axis of the LiDAR sensor.

The LiDAR sensor further comprises a receiver unit comprising an imaging unit and a detector, wherein the imaging unit is configured to direct the reflected laser radiation received from the scanner unit onto the detector.

The scanner unit is configured to adjust a relative position between the first and second lens array for adjusting the steering angle. Adjusting the relative position between the first and second lens array may comprise modifying or changing the relative position between the first and second lens array, for instance, in a range between ±5 mm.

A LIDAR sensor with a compact scanner unit is provided, which comprises at least two lens arrays (that may form a telescope setup) and an actuator for adjusting the relative position between the first and second lens array, which may have a stroke of less than 2 mm. The LiDAR sensor shows a superior detection range due to an expandable receiving aperture by scaling the number of lenses within each lens array. The reduction of the actuator stroke enables excellent mechanical stability, reduced costs and improved reliability of the system as used.

In an implementation form, the scanner unit is configured to adjust the steering angle based on a steering pattern (also referred to as scanning pattern). Different scanning patterns are possible as well as region of interest scanning is enabled by control parameters such as actuator movement pattern and velocity as well as the laser transmitter parameters (e.g. laser power, repetition rate, modulation frequency). By configuring these parameters, also the range performance of the LiDAR sensor can be adjusted dynamically according to the region of interest. Depending on requirements and the respective application scenario (e.g. autonomous driving on highways or in urban areas) the scanning pattern may be adjusted.

In an implementation form, the scanner unit comprises at least one actuator, wherein the at least one actuator is configured to adjust the position of the first lens array and/or the position of the second lens array in a first lateral direction and/or a second lateral direction perpendicular to the axis, wherein the first lateral direction is substantially perpendicular to the second lateral direction. The one or more actuators, which allow a beam steering in one dimension (1D) or two dimensions (2D), may be implemented as a voice coil motor, a piezo actuator, a magnetic actuator, an eccentric motor or a MEMS.

In an implementation form, the first and/or the second lens array comprises a plurality of refractive, reflective, diffractive and/or meta lens elements (also referred to as “lenslets”).

In an implementation form, each of the plurality of refractive lens elements comprises at least one optical surface with an acylindrical, aspheric or freeform shape.

In an implementation form, the first lens array and the second lens array form a telescope. The arrangement of the first and second lens array as a telescope leads to a simplified design of the receiver unit optics, as the reflected laser radiation leaving the scanner unit towards the receiver unit will be collimated and will have the same propagation direction independent of the current steering angle.

In an implementation form, the scanner unit further comprises a field lens array, wherein the field lens array is arranged between the first lens array and the second lens array or wherein the field lens array is a component of the first lens array and/or the second lens array. The field lens array improves the optical efficiency of the sensor and thus its detection range due to reducing vignetting losses at the first lens array and/or the second lens array.

In an implementation form, the transmitter unit comprises a laser configured to generate the laser radiation and a collimation unit configured to collimate the laser radiation along the axis in the direction of the first lens array and/or the second lens array.

In an implementation form, the laser radiation comprises a plurality of laser beams and wherein the collimation unit is configured to collimate the plurality of laser beams in the direction of one or more lens elements, also referred to as lenslets, of the first lens array and/or second lens array. The one or more optical elements may be configured such that each collimated laser beam is only passing a single lens element or single lenslet of each lens array. This configuration reduces straylight and optical losses caused by laser radiation hitting dead zones (due to manufacturing constraints) between the lens elements of each lens array.

In an implementation form, the LiDAR sensor further comprises a bandpass filter arranged between the scanner unit and the receiver unit. The angle of incidence (AOI) range on the bandpass filter may be minimized, which leads to a minimum wavelength shift of the filter bandpass and thus allowing a minimum bandpass spectral width. Consequently, more sunlight can be blocked and thus the detection range of the LiDAR sensor under sunlight conditions is increased.

In an implementation form, the scanner unit comprises one or more apertures and/or one or more optical baffles configured to block internal and/or external straylight. This allows improving the signal to noise ratio of the detector signal and thus the detection range.

In an implementation form, the scanner unit further comprises a position encoder configured to determine the lateral position of the second lens array relative to the first lens array. In combination with a calibration procedure this allows to precisely control the steering angle of the laser radiation emitted by the LiDAR sensor.

In an implementation form, the LIDAR sensor further comprises a control unit configured to implement a closed or open loop control scheme for adjusting the lateral position of the second lens array relative to the first lens array. This allows to precisely control the steering angle of the laser radiation emitted by the LiDAR sensor even under shock or vibration conditions.

In an implementation form, the first lens array comprises at least two lens arrays and the second lens array comprises at least two lens arrays. The at least two lens arrays may reduce optical aberrations of the scanner unit and consequently enable a sharp image of the one or more objects on the detector.

In an implementation form, the LiDAR sensor comprises at least one further transmitter unit configured to emit laser radiation along the axis of the LiDAR sensor and/or at least one further receiver unit comprising a further imaging unit and a further detector. As used herein, emitting laser radiation along the axis of the LiDAR sensor comprises emitting laser radiation parallel to the axis of the LiDAR sensor. The first and the second lens array are configured to emit the laser radiation received from the at least one further transmitter unit and to receive reflected laser radiation from the one or more objects at a steering angle relative to the axis of the LiDAR sensor and/or wherein the further imaging unit is configured to direct the reflected laser radiation received from the scanning unit onto the further detector.

In an implementation form, the LiDAR sensor further comprises one or more further optical elements, such as one or more prisms and/or mirrors, arranged in front of the second lens array, wherein the one or more further optical elements are configured to adapt the FOV of the LiDAR sensor. This allows to use the same basic LiDAR sensor arrangement for different applications, like short-range LIDAR with large FOV or long-range LIDAR with narrow FOV by only adapting the one or more further optical elements. This results in cost advantages due to economy of scale.

According to a second aspect an advanced driver assistance system (ADAS) is provided, wherein the ADAS comprises one or more LiDAR sensors according to the first aspect.

According to a third aspect a vehicle is provided, wherein the vehicle comprises one or more LiDAR sensors according to the first aspect and/or an ADAS according to the second aspect.

According to a fourth aspect a method of operating a LiDAR sensor for sensing one or more objects is provided. The method comprises the steps of: emitting, by a transmitter unit of the LIDAR sensor, laser radiation along an axis of the LiDAR sensor; emitting, by a first lens array and a second lens array of a scanner unit of the LiDAR sensor, the laser radiation received from the transmitter unit and receiving reflected laser radiation from the one or more objects at a steering angle relative to the axis of the LiDAR sensor; directing, by an imaging unit of a receiver unit of the LiDAR sensor, the reflected laser radiation received from the scanner unit onto a detector of the receiver unit; and adjusting a relative position between the first and second lens array for adjusting the steering angle.

According to a fifth aspect a computer program product is provided, comprising a computer-readable storage medium for storing program code which causes a computer or a processor to perform the method according to the fourth aspect, when the program code is executed by the computer or the processor.

The advantages of the apparatuses described above are the same as those for the corresponding implementation forms and the method according to the fourth aspect.

Details of one or more embodiments are set forth in the accompanying drawings and the description below.

### BRIEF DESCRIPTION OF THE DRAWINGS

In the following embodiments of the invention are described in more detail with reference to the attached figures and drawings, in which:

FIG. 1 is a schematic diagram illustrating a LiDAR sensor according to an embodiment:

FIGS. 2-4 show different exemplary scanning patterns implemented by a LiDAR sensor according to an embodiment:

FIGS. 5a and 5b show a schematic top view and side view of a LiDAR sensor according to a further embodiment:

FIG. 6 shows a graph illustrating the dependency between a lateral shift of the second lens array and a resulting steering angle of the LiDAR sensor according to an embodiment:

FIGS. 7a and 7b show schematic top views of a single lenslet channel of a scanner unit of the LiDAR sensor given in FIGS. 5a and 5b according to a further embodiment for two different steering angles:

FIG. 7c shows a table listing exemplary lens parameters for the embodiment of FIGS. 7a and 7b;

FIGS. 8a and 8b show a schematic top view and side view of a LiDAR sensor according to a further embodiment:

FIG. 9 shows a perspective view of a first and second 2 dimensional lens array of a scanner unit of a LiDAR sensor according to an embodiment:

FIG. 10 shows a flow diagram illustrating steps of a method of operating a LiDAR sensor according to an embodiment:

FIG. 11 shows a schematic diagram of an advanced driver assistance system according to an embodiment comprising a LiDAR sensor according to an embodiment; and

FIG. 12 shows a top view of a vehicle according to an embodiment comprising an advanced driver assistance system according to an embodiment.

In the following identical reference signs refer to identical or at least functionally equivalent features.

### DETAILED DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units. e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

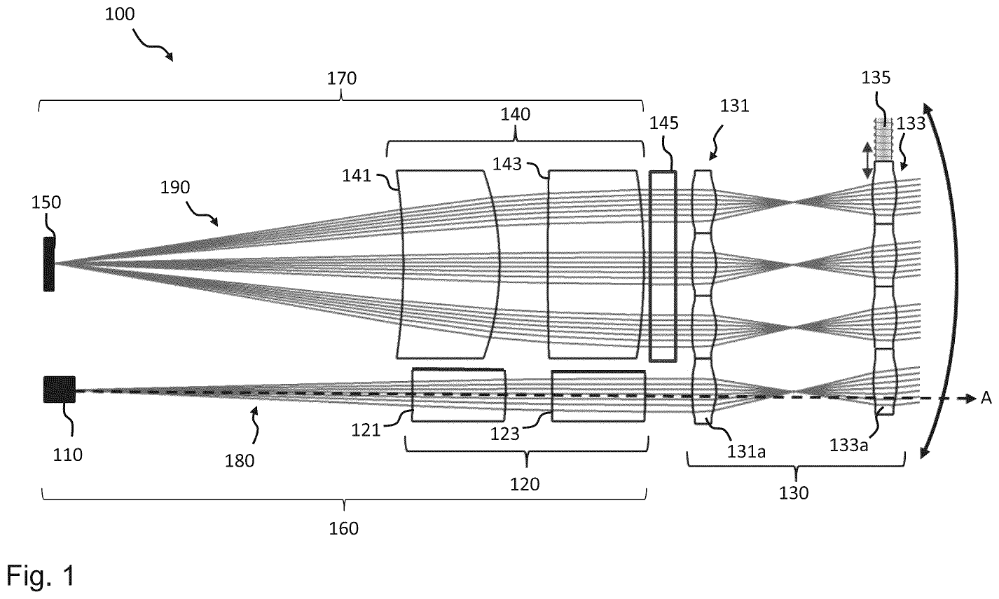

FIG. 1 is a schematic diagram illustrating a LiDAR sensor 100 according to an embodiment. The LiDAR sensor 100 comprises a transmitter unit 160 configured to emit laser radiation along an axis A of the LiDAR sensor 100. As can be taken from FIG. 1, the axis A may be a longitudinal axis of the LiDAR sensor 100 and/or may substantially correspond to the optical axis of the LiDAR sensor 100. The transmitter unit 160 may comprise a laser 110 configured to generate the laser radiation and a collimation unit 120 including one or more optical elements. e.g. lenses 121, 123 configured to collimate the laser radiation along the axis A. The laser radiation may comprise one or more laser beams. As illustrated in FIG. 1, the laser radiation emitted by the laser 110 propagates along a transmission path 180 of the LiDAR sensor 100.

The LiDAR sensor 100 further comprises a scanner unit 130 comprising a first lens array 131 and a second lens array 133 arranged substantially perpendicular to the axis A. As illustrated in FIG. 1, the first and the second lens array 131, 133 are configured to emit the laser radiation received along the transmission path 180 from the one or more optical elements 121, 123 of the collimation unit 120 of the transmitter unit 160 and to receive reflected laser radiation from the one or more objects along a reception path 190 at a steering angle relative to the axis A of the LiDAR sensor 100. In an embodiment, the first and/or the second lens array 131, 133 comprises a plurality of refractive, reflective, diffractive and/or meta lens elements (also referred to as “lenslets”). An exemplary lens element 131a of the first lens array 131 and an exemplary lens element 133a of the second lens array 133 are shown in FIG. 1. Each of the plurality of refractive lens elements may comprise at least one optical surface with an acylindrical, aspheric or freeform shape.

The LiDAR sensor 100 further comprises a receiver unit 170 comprising an imaging unit 140 and a detector 150, wherein the imaging unit 140 is configured to direct the reflected laser radiation received from the scanner unit 130 along the reception path 190 onto the detector 150. As illustrated in FIG. 1, the imaging unit 140 may comprise one or more lenses 141, 143 for directing the reflected laser radiation received from the scanner unit 130 onto the detector 150. In the embodiment shown in FIG. 1, the LiDAR sensor 100 further comprises a bandpass filter 145, which may be arranged along the reception path 190 between the first lens array 131 and the imaging unit 140 of the receiver unit 170.

As will be described in more detail below, the scanner unit 130 is configured to adjust a relative position between the first and second lens array 131, 133 for adjusting, e.g. changing or modifying the steering angle relative to the axis A of the LiDAR sensor 100. In an embodiment, the scanner unit 130 is configured to adjust the relative position between the first and second lens array 131, 133 by laterally moving e.g. substantially perpendicular to the axis A the first lens array 131 and/or the second lens array 133. To this end, in an embodiment, the scanner unit 130 comprises at least one actuator 135, wherein the at least one actuator 135 is configured to adjust the position of the first lens array 131 and/or the position of the second lens array 133 in a first lateral direction and/or a second lateral direction perpendicular to the axis A, wherein the first lateral direction is substantially perpendicular to the second lateral direction. The one or more actuators 135, which allow a beam steering in one dimension (ID) or two dimensions (2D), may be implemented as a voice coil motor, a piezo actuator, a magnetic actuator, an eccentric motor or a MEMS.

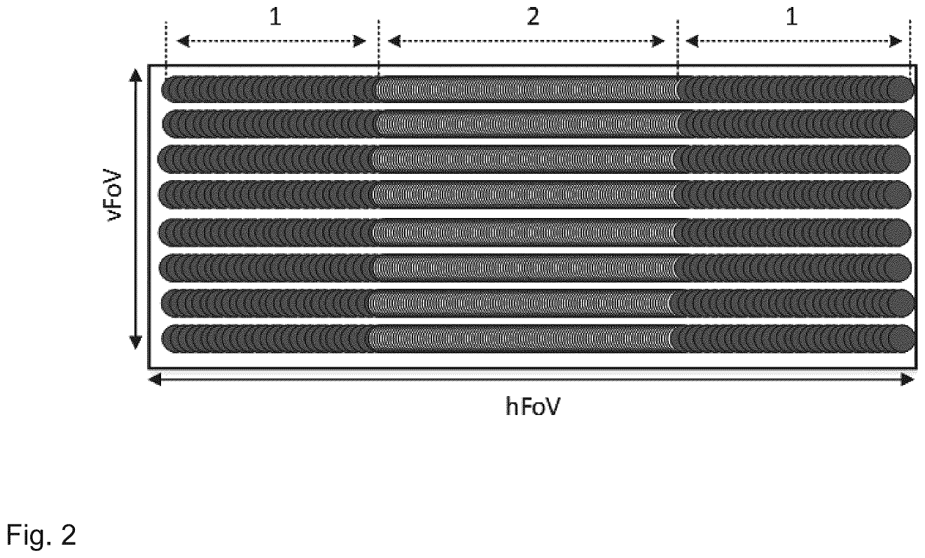

In an embodiment, the scanner unit 130, for instance by means of the one or more actuators 135, is configured to adjust the steering angle based on a steering or scanning pattern. Different scanning patterns are possible as well as region of interest scanning is enabled by control parameters such as actuator movement pattern and velocity as well as the laser parameters (e.g. laser power, repetition rate, modulation frequency). Also, the range performance of the LiDAR sensor 100 can be adjusted dynamically according to the region of interest by proper configuration of these parameters. Thus, dependent on requirements and the respective application scenarios (e.g. autonomous driving on highways or in urban areas) the scanning pattern may be adjusted. FIGS. 2, 3 and 4 show different exemplary scanning patterns implemented by the LiDAR sensor 100 according to an embodiment.

A scanning pattern illustrates the propagation direction of the laser radiation (which may comprise one or more pulsed laser beams) at various moments in time in angular space with respect to the axis A, meaning that the vertical axis represents the vertical field of view (vFOV) and the horizontal axis represents the horizontal field of view (hFOV) of the LiDAR sensor 100. Thus each spot in FIGS. 2, 3 and 4 represents a single laser beam pointing into a particular direction. After changing the steering angle by the scanner unit 130, the beam is moved in angular space to another position.

FIG. 2 shows a scanning pattern with a central region of interest 2 (illustrated by the light dots) using a 1-dimensional scanner unit 130 and a laser 110 configured to generate 8 laser beams which are arranged in angular space along the vertical direction. The steering direction of the scanner unit 130 is along the horizontal direction. In this region of interest 2, the resolution of the LiDAR sensor 100 is higher compared to the lower point density in the regions 1 (illustrated by the dark dots). For a constant laser repetition rate such higher resolution in the region of interest 2 can be realized e.g. by reducing the velocity of the movement of the actuator 135.

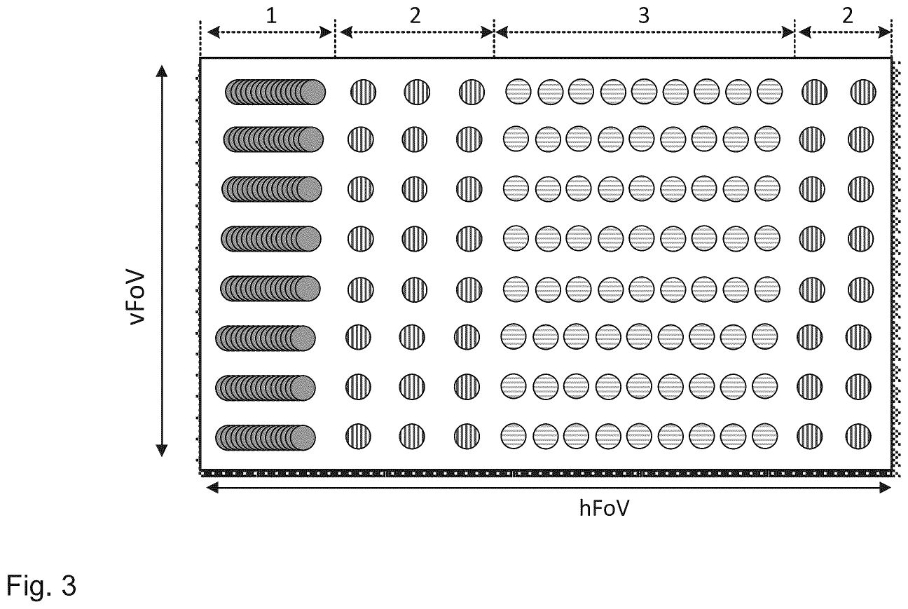

FIG. 3 shows a scanning pattern realized by the same LiDAR sensor 100 as the one used for FIG. 2. The regions 1, 2, and 3 have a different resolutions. In region 1 the actuator 135 is continuously moved resulting in a constant change of the steering angle in time and thus, an overlap of the different laser beams in the scan pattern (as illustrated by the solid dots). In region 2 and 3 the actuator movement pattern is discrete (e.g. in jumps with a particular increment length) resulting in separated laser beams. The increment length of the jumps in region 2 is twice as the increment length in region 3.

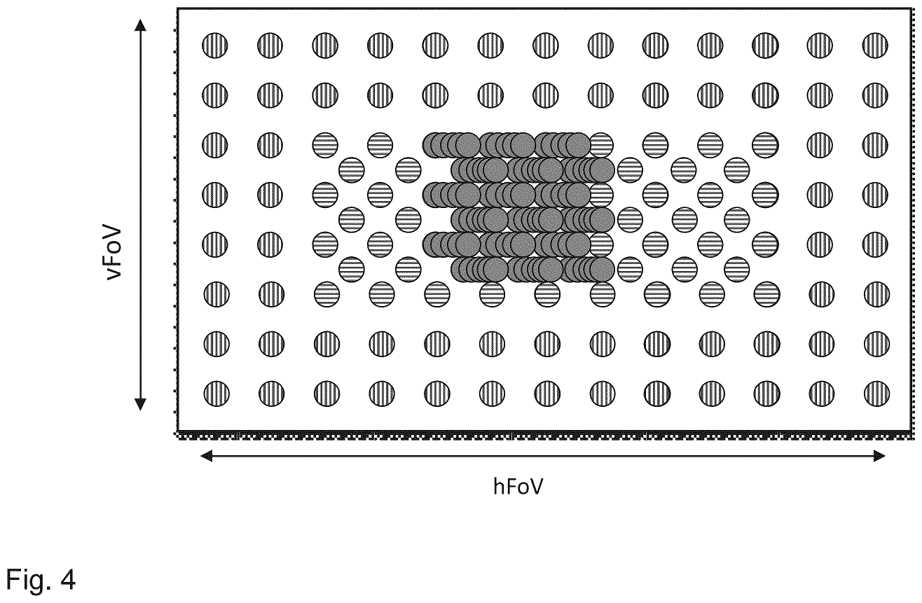

FIG. 4 shows an exemplary scanning pattern for a 2-dimensional scanner unit 130 with three zones with different resolutions. In a first region (illustrated by horizontally shaded dots) and a second region (illustrated by vertically shaded dots) there is a discrete actuator movement and in a third region (illustrated by the solid dots) there is a mix of continuous movement with discrete jumps in between.

In an embodiment, the scanner unit 130 further comprises a position encoder configured to determine the lateral position of the second lens array 133 relative to the first lens array 131. In combination with a calibration procedure this allows to precisely control the steering angle of the laser radiation emitted by the LiDAR sensor 100. In an embodiment, the LiDAR sensor 100 may further comprise a control unit configured to implement a closed or open loop control scheme for adjusting the lateral position of the second lens array 133 relative to the first lens array 131. This allows to precisely control the steering angle of the laser beam emitted by the LiDAR sensor 100 even under shock or vibration conditions.

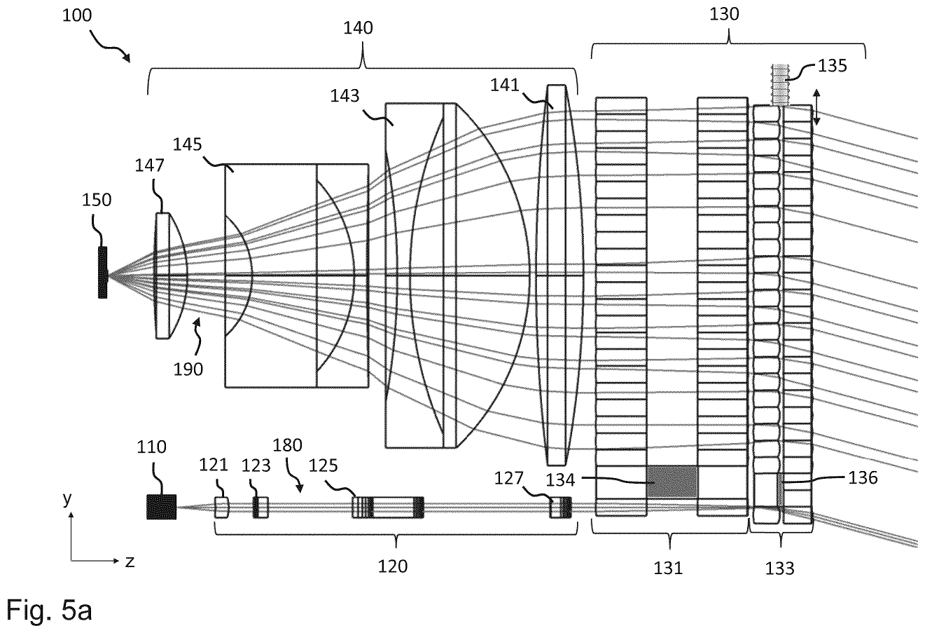

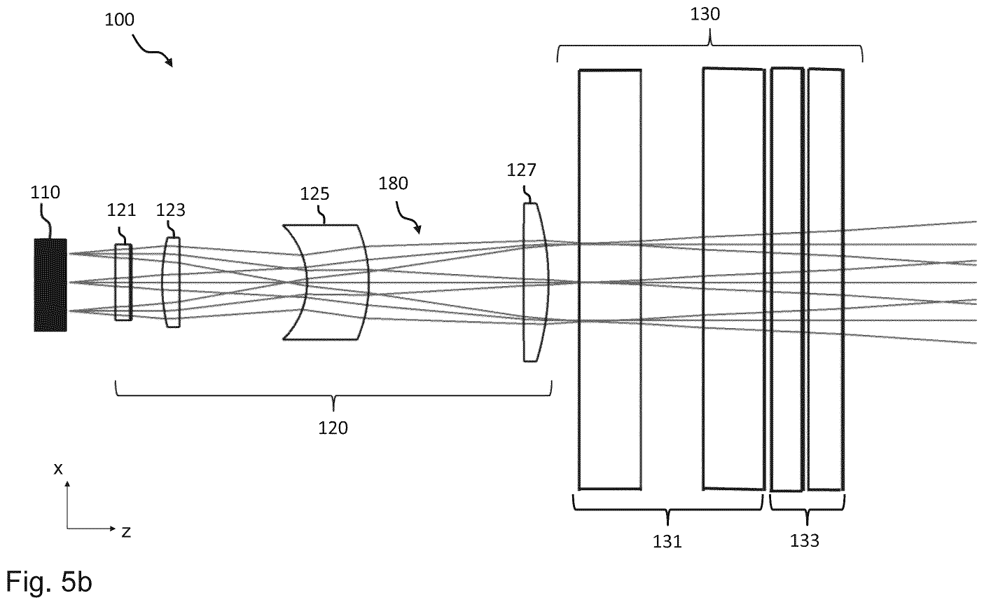

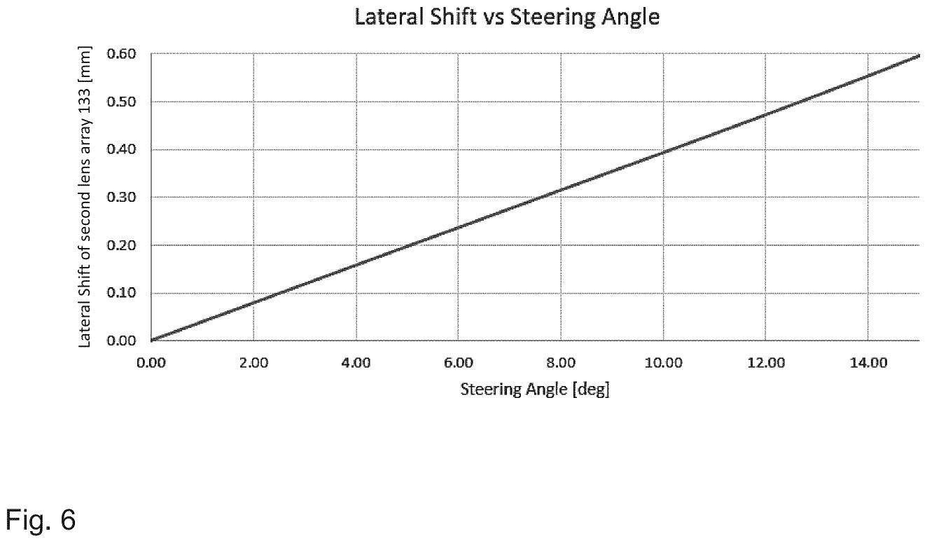

FIGS. 5a and 5b show the top view (y-z plane) and side view (x-z plane) of a further embodiment of the LiDAR sensor 100, respectively. The optical layout shown in FIGS. 5a and 5b provides the LiDAR sensor 100 with a field of view (FOV) of 7.5 degrees in vertical (y-) direction and 30 degrees in horizontal (x-) direction. The horizontal FOV may be realized by an array of 75 vertical cavity surface emitting lasers (VCSELs) 110, which are aligned along a line in vertical direction. For the purpose of clarity only 3 exemplary beam paths are given in FIG. 5b. The 75 laser beams generated by the lasers 110 are collimated and distributed equidistant along a line in the vertical FOV direction by an anamorphic collimation unit 120 consisting of 4 acylindrical lenses 121, 123, 125 and 127. This line of 75 laser beams (called laser line in the following) is now steered along the horizontal FOV using the 1-dimensional scanner unit 130, which consists of 2 first acylindrical lens arrays 131 and 2 second acylindrical lens arrays 133. Thus, as will be appreciated, in comparison with the embodiment shown in FIG. 1 in the embodiment shown in FIGS. 5a and 5b the first lens array 131 comprises two lens arrays and the second lens array 133 comprises two lens arrays. Depending on the lateral shift of the second acylindrical lens arrays 133 with respect to the first acylindrical lens arrays 131, the steering angle of the laser line can be adjusted. FIG. 6 gives the steering angle as a function of this lateral shift. To ensure a sufficient collimation of the 75 laser beams, the optical aberrations introduced by the acylindrical lens arrays 131 and 133 may be minimized for all relevant steering angles. For this reasons, as already described above, each lens array 131, 133 consists of two individual acylindrical lens array elements in the embodiment shown in FIGS. 5a and 5b. Furthermore, these two lens arrays 131, 133 form a telescope arrangement including a field lens array. This arrangement minimizes the vignetting or scattering of the laser beams in-between the single lens elements 131a. 133a of each lens array (in the so-called dead zones) to avoid the reduction of the optical efficiency of the LiDAR sensor 100. The entire laser radiation of the transmission path 180 is only passing through a single acylindrical lenslet 131a, 133a of each lens array 131, 133. Otherwise, due to the periodic nature of the lens arrays 131, 133, higher diffraction orders may result in the appearance of straylight, which may have a negative impact on the signal to noise ratio (SNR) of the detector 150 and, thus, on detection range of the LiDAR sensor 100. In the embodiment shown in FIGS. 5a and 5b, the scanner unit 130 further comprises one or more optical baffles 134, 136 between the individual acylindrical lens array elements 131a, 133a of the lens arrays 131, 133 to avoid a cross talk of straylight from the transmission (Tx) path 180 towards the reception (Rx) path 190. These optical baffles 134, 136 also can be used as spacers to guarantee a precise axial distance between the lens arrays within the lens arrays 131, 133. After the laser radiation has passed the second acylindrical lens array 133, it propagates towards the scene and gets back reflected by one or more objects. This back reflected laser radiation hits the scanner unit 130 again, which deflects the back reflected laser radiation towards the receiver optics, e.g. the imaging unit 140, which generates an image on the single-photon avalanche diode (SPAD) array detector 150. As there is a VCSEL laser line consisting of 75 laser beams in the transmission path 180, the SPAD array detector 150 will also only consists of 75 bins or super pixels arranged along a vertical line. For improvement of the dynamic range and SNR, typically each bin or super pixel may be formed by several real SPAD pixels. Thus, in an embodiment, each laser beam emitted by a VCSEL may match with a single SPAD detector super pixel. This matching of VCSEL beams with SPAD detector super pixels may be guaranteed for all steering angles as the transmission and reception optical paths 180, 190 are sharing the same first and second lens array 131, 133 and the same actuator 135. Consequently, the scanning angles for the Rx and Tx paths 190, 180 are always identical. This has the advantage that no complex synchronization between Rx's and Tx's beam steering angles is necessary. The absolute steering angle of the LiDAR sensor 100 can simply be determined by adding an encoder or position sensor on the actuator 135 or the second lens arrays 133 to measure the lateral shift. To increase the detection range, the back reflected light from one or more objects is emitted through several lens elements 131a, 133a of each lens array 131, 133 to maximize the aperture of the receiver unit 170.

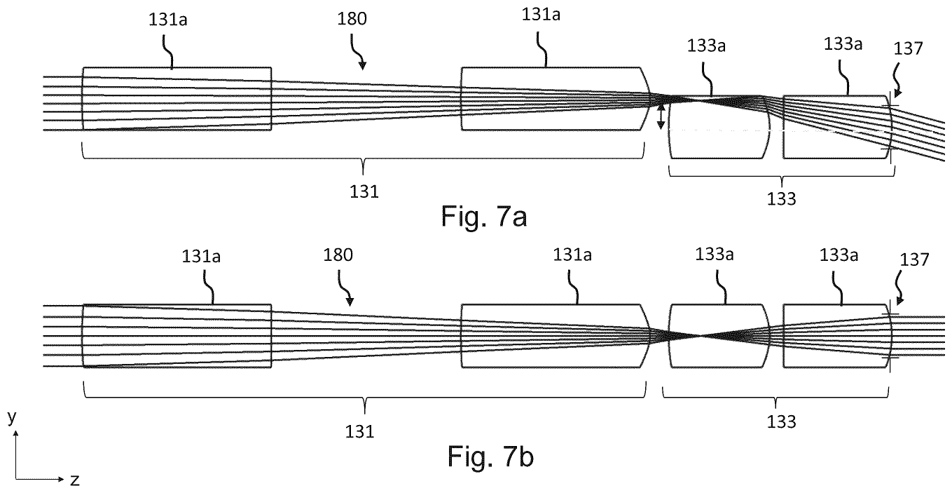

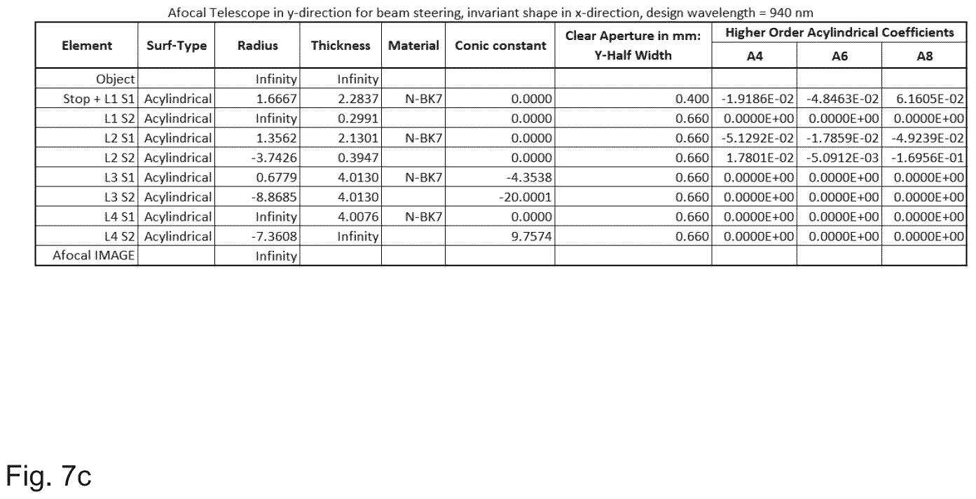

FIGS. 7a and 7b show the transmission path 180 for exemplary steering angles of 15 and 0) degrees through a single lenslet channel 131a, 133a of the scanner unit 130 of the LiDAR scanner 100 given in FIGS. 5a and 5b. As will be appreciated, this afocal lenslet channel is identical for the reception path 190, except of the inverse propagation direction and that the reception path 190 consists of multiple of these channels, which are laterally arranged to each other. Thus, the lens arrays 131, 133 are basically formed by a periodic replication of a single lenslet channel 131a, 133a in a direction substantially perpendicular to the axis A. The pitch of the periodic replication in the lens arrays 131, 133 is 1.32 mm. The periodicity is only broken for the optical baffles 134, 136 in between the reception and transmission path 190, 180. The dead zones between the lenses 131a, 133a of an individual array may be coated by an absorbing or reflective layer 137, e.g. a black chromium layer 137 to avoid the generation of straylight. As depicted in FIGS. 7a and 7b, there is an intermediate focus. Thus, each channel 131a, 133a forms a telescope. By controlling the ratio between the focal lengths of the elements 131a, 133a on either side of the intermediate focus, the angular magnification of this telescope and thus the maximum steering angle for a given maximum stroke of the actuator 135 can be controlled. This telescope angular magnification also controls the vignetting of the laser radiation at the lens array dead zones and thus has significant impact on the overall optical collection efficiency of the LiDAR sensor 100.

As is depicted in FIGS. 7a and 7b, the collimated laser radiation towards the receiver and transmitter units 170, 160 is independent from the steering angle, parallel to the axis A. This simplifies the complexity and costs of the receiver and transmitter units 170, 160, as these units need to deal only with a maximum FOV of 7.5 degrees which is given by the vertical FOV. In addition, the afocal scanner architecture has the advantage that the angle of incidence (AOI) range on the bandpass filter 145, which may be placed between the receiver and scanner unit 170, 130, is reduced also to this 7.5 degrees. A reduced AOI range, improves the overall LiDAR sensor 100 detection range under sunlight conditions due to the reduced wavelength shift of the bandpass filter 145.

The table shown in FIG. 7c provides the optical data of the single lenslet channel 131a, 133a shown in FIGS. 7a and 7b. The sequence of the surfaces mentioned in the table of FIG. 7c is defined in the direction from the one or more objects towards the receiver 170 and transmitter unit 160. The acylindrical surface referred to in the table shown in FIG. 7c is the cylindrical counterpart to an aspheric surface and can be described by the following equation:

$$z = \frac{c \cdot {y}^{2}}{1 + \sqrt{1 - ( 1 + k ) {c}^{2} \cdot {y}^{2}}} + {A}_{4} {y}^{4} + {A}_{6} {y}^{6} + {A}_{8} {y}^{8}$$

where:
z denotes the sag of the surface parallel to the z-axis,
y denotes the lateral distance in y-direction,
1/c denotes the radius of curvature,
k denotes the conic constant, and
A₄, A₆ and A₈ denote the 4^{th}, 6^{th}, and 8^{th} higher order deformations coefficients, respectively.

The embodiments of the LiDAR sensor 100 shown in FIGS. 5a, 5b and 7a, 7b may exhibit one or more of the following properties: an expandable receiving aperture by scaling the number of lenslets 131a, 133a within each lens array 131, 133 which enables long detection ranges; a compact, e.g. short system length; only small (<2 mm) strokes of the actuator 135 are required, which improves the mechanical stability and reliability of the scanner unit 130 of the LiDAR sensor 100; Rx and Tx path 190, 180 integration within the same lens arrays 131, 133, e.g. there is no complex scanning synchronization between Rx and Tx paths 190, 180 necessary and a single actuator 135 is sufficient; no bulky scanning mirror necessary; only simple and small 1-dimensional VCSEL lines and SPAD arrays 110, 150 may be used for the transmitter unit 160 and the receiver unit 170.

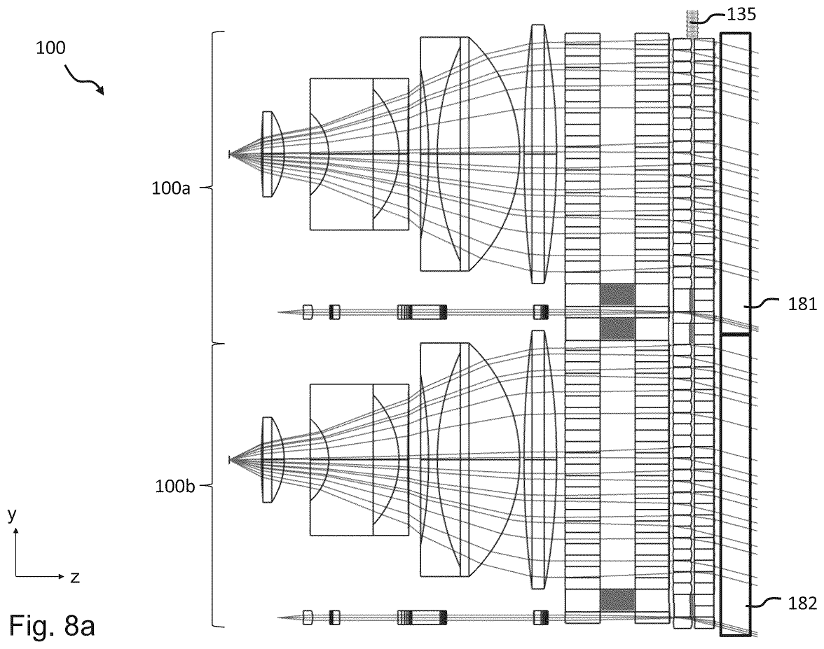

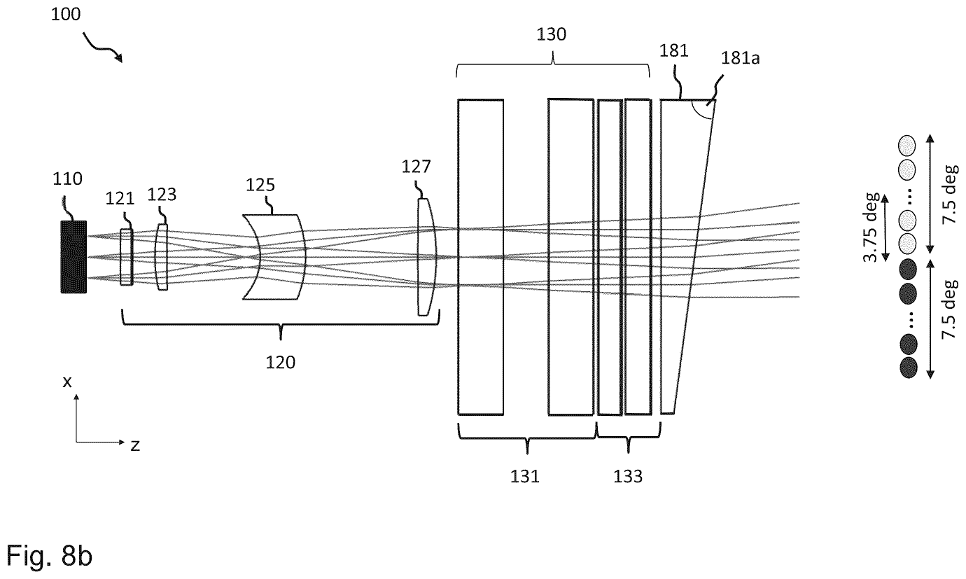

FIGS. 8a and 8b show the top view (y-z plane) and side view (x-z plane) of a further embodiment of the LiDAR sensor 100. For the optical layout shown in FIGS. 8a and 8b the LiDAR sensor 100, by way of example, has a field of view (FOV) of 15 deg in vertical (v-) direction and 30 deg in horizontal (x-) direction. The LiDAR sensor 100 consist of two LiDAR modules 100a. 100b, wherein each LiDAR module 100a, 100b is configured according to the embodiment described in the context of FIGS. 5a and 5b above. As depicted in FIGS. 8a and 8b, the two LiDAR modules 100a, 100b are arranged side by side with their respective axis being parallel to another. In the embodiment shown in FIGS. 8a and 8b the two LiDAR modules 100a, 100b share the single scanner unit 130 and the one actuator 135. In front of the scanner unit 130 there may be provided a respective wedge prism 181 and 182 for each LiDAR module 100a, 100b. These prisms 181 and 182 may have different wedge angles 181a or different orientations to realize an offset between the two laser lines (one laser line emitted per LiDAR module 100a, 100b) as illustrated by the different shades of grey in FIG. 8b, where the angular offset realized by a first prism 181 may be 3.75 degrees. A second prism 182 may have a similar wedge angle 181a as the first prism 181 but is rotated by 180 degrees around the z-axis, resulting in a laser line angular offset of −3.75 degrees for the second LiDAR module 100b. Consequently, the vertical FOV of the stacked system consisting of the two LiDAR modules 100a, 100b can be doubled compared to the vertical FOV of a single LiDAR module 100a. 100b.

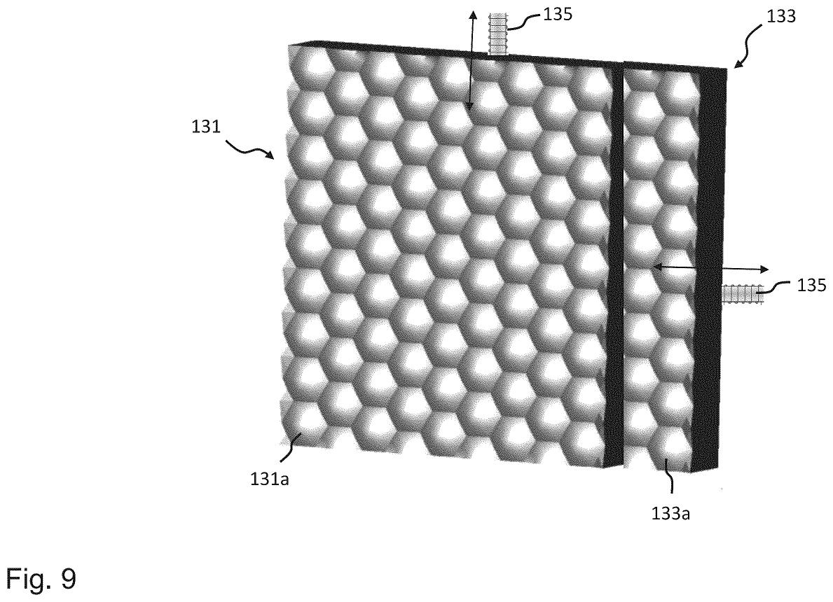

FIG. 9 shows an embodiment of the scanner unit 130 of the LiDAR sensor 100 for 2-dimensional beam steering. In this case aspheric lenslets (such as the exemplary lenslets 131a, 133a) are arranged in a hexagonal lens array 131, 133. Each of the lens arrays 131, 133 may be laterally shifted in one direction by a respective actuator 135. The lateral shift direction of the first lens array 131 and the second lens array 133 may be orthogonal to each other enabling a 2-dimensional steering of the laser direction.

The embodiment of the scanner unit 130 of the LiDAR sensor 100 shown in FIG. 9 may exhibit one or more of the following properties: the hexagonal arrangement of the lens arrays 131, 133 may reduce the amount of optical losses due to vignetting at dead zones, thereby improving the optical efficiency of the scanner unit 130 and, thus, increasing the detection range of the LiDAR sensor 100; 2-dimensional beam steering further reduces the number of beams generated by the laser 110 and the detector 150 area, because for this embodiment only a single laser beam and a single detector pixel are sufficient. This embodiment is very interesting for FMCW LiDAR sensors 100 operating at a wavelength of 1550 nm, as here the number of emitter (e.g. fiber laser) and the number of detector pixels (e.g. avalanche photodiodes) is typically strongly limited due to cost reasons.

In a variant of the embodiment shown in FIGS. 8a and 8b, the prisms 181, 182 for realizing the angular offset may be obsolete if an aperiodic lens array (so called chirped lens arrays, where the distance between the lenslet centers is not on a periodic grid but is varying by a defined function) is used as the second lens array 133. As it will be further appreciated, the lenslet shapes of each of the lens arrays 131, 133 for the Rx and Tx path 190, 180 may have a different sag profile or aperture diameter. This may be selected depending on the exact shape of the laser beam. In a further embodiment, the one or more prisms 181, 182 may be replaced by an inverted afocal beam expander to enhance the FOV.

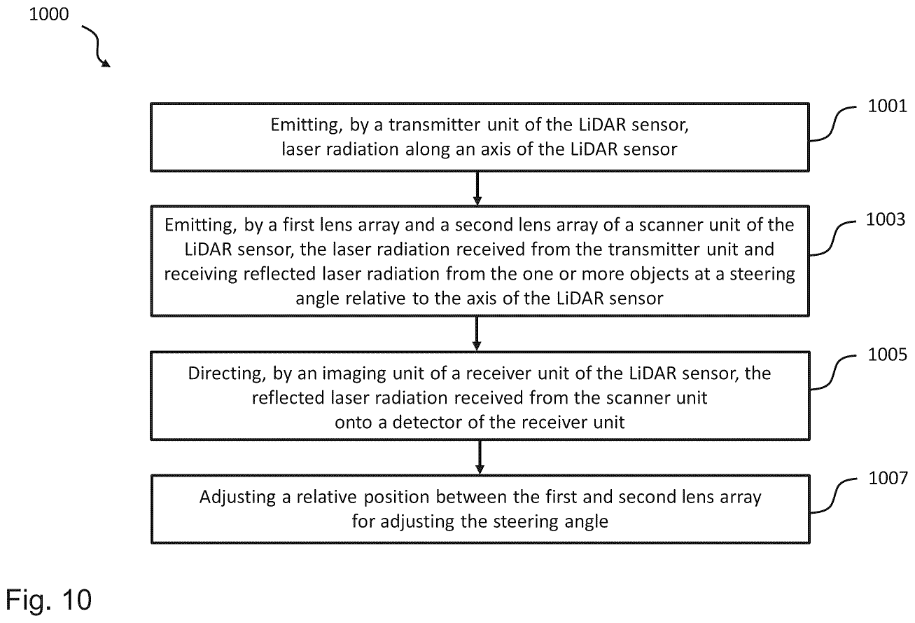

FIG. 10 shows a flow diagram illustrating a method 1000 of operating the LiDAR sensor 100 for sensing one or more objects. The method 1000 comprises a first step 1001 of emitting, by the transmitter unit 160 of the LiDAR sensor 100, laser radiation along the axis A of the LiDAR sensor 100. The method 1000 further comprises a step 1003 of emitting, by the first lens array 131 and the second lens array 133 of the scanner unit 130 of the LiDAR sensor 100, the laser radiation received from the transmitter unit 160 and receiving reflected laser radiation from the one or more objects at a steering angle relative to the axis A of the LiDAR sensor 100. Moreover, the method 1000 comprises a step 1005 of directing, by the imaging unit 140 of the receiver unit 170 of the LiDAR sensor 100, the reflected laser radiation received from the scanner unit 130 onto the detector 150 of the receiver unit 170. The method 1000 further comprises a step 1007 of adjusting a relative position between the first and second lens array 131, 133 for adjusting the steering angle.

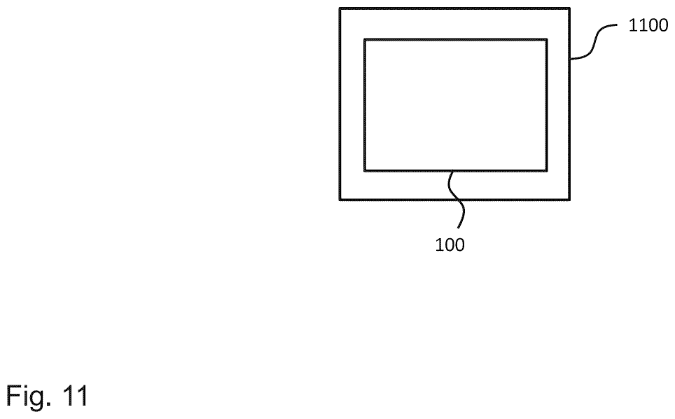

FIG. 11 shows a schematic diagram of an advanced driver assistance system, ADAS, 1100 according to an embodiment comprising the LiDAR sensor 100 according to an embodiment.

FIG. 12 shows a top view of a vehicle, in particular a car 1200 according to an embodiment comprising the advanced driver assistance system 1100 according to an embodiment.

The person skilled in the art will understand that the “blocks” (“units”) of the various figures (method and apparatus) represent or describe functionalities of embodiments (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments may be integrated into one processing unit, or each of the units may exist alone physically, or two or more units are integrated into one unit.

1. A light detection and ranging (LiDAR) sensor for sensing one or more objects, comprising:
a transmitter configured to emit laser radiation along an axis of the LiDAR sensor;
a scanner comprising a first lens array and a second lens array, wherein the first and the second lens array are configured to emit the laser radiation received from the transmitter and to receive reflected laser radiation from the one or more objects at a steering angle relative to the axis of the LiDAR sensor; and
a receiver comprising an imager and a detector, wherein the imager is configured to direct the reflected laser radiation received from the scanner onto the detector;
wherein the scanner is configured to adjust a relative position between the first and second lens array for adjusting the steering angle.

2. The LiDAR sensor of claim 1, wherein the scanner is configured to adjust the steering angle based on a steering pattern.

3. The LiDAR sensor of claim 1, wherein the scanner comprises at least one actuator, wherein the at least one actuator is configured to adjust a position of the first lens array and/or a position of the second lens array in a first lateral direction and/or a second lateral direction perpendicular to the axis, wherein the first lateral direction is perpendicular to the second lateral direction.

4. The LiDAR sensor of claim 1, wherein the first and/or the second lens array comprises a plurality of refractive, reflective, diffractive, and/or meta lens elements.

5. The LiDAR sensor of claim 4, wherein each of the plurality of refractive lens elements comprises at least one optical surface with an acylindrical, aspheric, or freeform shape.

6. The LiDAR sensor of claim 1, wherein the first lens array and the second lens array form a telescope.

7. The LiDAR sensor of claim 6, wherein the scanner further comprises a field lens array, wherein the field lens array is arranged between the first lens array and/or the second lens array or wherein the field lens array is a component of the first lens array and/or the second lens array.

8. The LiDAR sensor of claim 1, wherein the transmitter comprises a laser configured to generate the laser radiation and a collimation unit configured to collimate the laser radiation along the axis in the direction of the first lens array and/or second lens array.

9. The LiDAR sensor of claim 8, wherein the laser radiation comprises a plurality of laser beams and wherein the collimation unit is configured to collimate the plurality of laser beams in the direction of one or more lens elements of the first lens array and/or one or more lens elements of the second lens array.

10. The LiDAR sensor of claim 1, wherein the LiDAR sensor further comprises a bandpass filter arranged between the scanner and the receiver.

11. The LiDAR sensor of claim 1, wherein the scanner comprises one or more apertures and/or one or more optical baffles configured to block internal and/or external stray light.

12. The LiDAR sensor of claim 1, wherein the scanner further comprises a position encoder configured to determine a lateral position of the second lens array relative to the first lens array.

13. The LiDAR sensor of claim 12, wherein the LiDAR sensor further comprises a control unit configured to implement a closed or open loop control scheme for adjusting the lateral position of the second lens array relative to the first lens array.

14. The LiDAR sensor of claim 1, wherein the first lens array comprises at least two lens arrays and/or the second lens array comprises at least two lens arrays.

15. The LiDAR sensor of claim 1, wherein the LiDAR sensor comprises at least one additional transmitter configured to emit the laser radiation along the axis of the LiDAR sensor and/or at least one additional receiver comprising an additional imager and an additional detector, wherein the first and the second lens array are configured to emit the laser radiation received from the at least one additional transmitter and to receive the reflected laser radiation from the one or more objects at the steering angle relative to the axis of the LiDAR sensor and/or wherein the additional imager is configured to direct the reflected laser radiation received from the scanner onto the additional detector.

16. The LiDAR sensor of claim 1, wherein the LiDAR sensor further comprises one or more optical elements arranged in front of the second lens array, wherein the one or more optical elements are configured to adapt a field of view of the LiDAR sensor.

17. An advanced driver assistance system (ADAS) for a vehicle, wherein the ADAS comprises one or more LiDAR sensors, wherein the LiDAR sensor for sensing one or more objects, comprises:
a transmitter configured to emit laser radiation along an axis of the LiDAR sensor;
a scanner comprising a first lens array and a second lens array, wherein the first and the second lens array are configured to emit the laser radiation received from the transmitter and to receive reflected laser radiation from the one or more objects at a steering angle relative to the axis of the LiDAR sensor; and
a receiver comprising an imager and a detector, wherein the imager is configured to direct the reflected laser radiation received from the scanner onto the detector;
wherein the scanner is configured to adjust a relative position between the first and second lens array for adjusting the steering angle.

18. The ADAS of claim 17, wherein the scanner is configured to adjust the steering angle based on a steering pattern.

19. The ADAS of claim 17, wherein the scanner comprises at least one actuator, wherein the at least one actuator is configured to adjust a position of the first lens array (134) and/or a position of the second lens array in a first lateral direction and/or a second lateral direction perpendicular to the axis, wherein the first lateral direction is perpendicular to the second lateral direction.

20. The ADAS of claim 17, wherein the first and/or the second lens array comprises a plurality of refractive, reflective, diffractive, and/or meta lens elements.
